(19) United States
(12) Patent Application Publication
(10) Pub. No.: US 2015/0199512 A1
(43) Pub. Date: Jul. 16, 2015

(54) APPARATUS AND METHOD FOR DETECTING ABNORMAL BEHAVIOR

(71) Applicant: ELECTRONICS AND TELECOMMUNICATIONS RESEARCH INSTITUTE, DAEJEON (KR)

(72) Inventors: Hyun Joo KIM, Daejeon (KR); Ik Kyun KIM, Daejeon (KR)

(73) Assignee: ELECTRONICS AND TELECOMMUNICATIONS RESEARCH INSTITUTE, DAEJEON (KR)

(21) Appl. No.: 14/248,845

(22) Filed: Apr. 9, 2014

(30) Foreign Application Priority Data
Jan. 13, 2014 (KR) 10-2014-0003781

(51) Int. Cl. G06F 21/55

(52) U.S. Cl. CPC G06F 21/55

(57) ABSTRACT

Provided are abnormal behavior detecting apparatus and method and the abnormal behavior detecting apparatus, includes: a behavior analyzing unit which analyzes a behavior which occurs for resources of a system based on data collected from a process while the process is executed on the system; a behavior modeling unit which models a behavior analysis result for the resources of the system on a coordinate which is generated based on the behavior for the resources of the system to create a process behavior model corresponding to the resources of the system; a suspicious behavior determining unit which determines a suspicious behavior of the process in accordance with the type of the process behavior model which is implemented on the coordinate; and a process detecting unit which detects a process in which the suspicious behavior occurs as an abnormal behavior process.

### CROSS-REFERENCE TO RELATED APPLICATIONS

This application claims priority to and the benefit of Korean Patent Application No. 10-2014-0003781 filed in the Korean Intellectual Property Office on Jan. 13, 2014, the entire contents of which are incorporated herein by reference.

### TECHNICAL FIELD

The present invention relates to an apparatus and a method for detecting abnormal behavior, and more particularly to a technique which analyzes data collected in a system to detect a process which performs abnormal behavior.

### BACKGROUND ART

A cyber target attack is an intelligent cyber attack which covertly infiltrates a network of an organization such as a corporation or an institution through various methods and remains latent for a long time to aim to leak confidential information or control main facilities.

Such an attack is performed over a long time, rather than at one time and uses various malicious codes or attack routes so that it is difficult to detect the attack in advance or cope with the attack. Further, in order to detect the cyber target attack, massive data needs to be collected and analyzed for a long time from various sources of the organization, for example, a network, a host, a server, or security equipment.

However, intelligent security information and event management (SIEM) of the related art does not support a platform which may store and analyze massive data for a long time. To this end, even though a big data platform is introduced in a security management field in recent years, the utilization thereof is still inadequate.

A malicious code detecting method of the related art includes a pattern signature method which statically/dynamically analyzes a code and a heuristic method which blocks popular programs having a pseudo code pattern. In this case, the signature method is a pattern matching method so that the malicious code is exactly detected but a malicious code which is modified or not well known is hard to detect. Further, the heuristic method supplements the signature method based on a pseudo code pattern.

Recently, even though a behavior based analyzing method through observation of an action of the process is provided, the method performs the detection based on a scenario which is already known so that the method cannot detect abnormal behavior which is not present in the scenario or an abnormal behavior of the normal process, or suspicious behavior when the behavior is performed for a long time so that a behavior sequence is hardly figured out. Further, a user may not intuitively distinguish a behavior of a normal process and a process which performs an abnormal behavior.

### SUMMARY

The present invention has been made in an effort to provide an apparatus and a method for detecting an abnormal behavior which analyze a behavior of data occurring during a process operation for resources of a system and visualize the behavior in a behavior area corresponding to the resources of the system to detect a process which performs an abnormal or suspicious behavior in accordance with a behavior distribution for the resources of the system.

The present invention has been made in an effort to further provide an apparatus and a method for detecting an abnormal behavior which models a normal behavior and behaviors of a malicious code or suspicious behaviors for the resources of the system to detect a process, which performs an abnormal or specious behavior, through the behavior model.

The present invention has been made in an effort to further provide an apparatus and a method for detecting an abnormal behavior which detect suspicious behaviors which occur during a prior preparation process of the malicious code for performing the malicious behavior to cope with a cyber target attack in advance.

An exemplary embodiment of the present invention provides an abnormal behavior detecting apparatus, including: a behavior analyzing unit which analyzes a behavior which occurs for resources of a system based on data collected from a process while the process is executed on the system; a behavior modeling unit which models a behavior analysis result for each resource of the system on a coordinate which is generated based on the behavior for the each resource of the system to create a process behavior model corresponding to the each resource of the system; a suspicious behavior determining unit which determines a suspicious behavior of the process in accordance with the type of process behavior model which is implemented on the coordinate which is generated based on the behavior for the each resource of the system; and a process detecting unit which detects a process in which the suspicious behavior occurs as an abnormal behavior process in accordance with the determining result of the suspicious behavior determining unit.

The behavior analyzing unit may analyze at least one of a ratio, a frequency, and a correlation of the behavior which occurs for the resources of the system.

The resource of the system may include a file, a process, a registry, and a network.

The coordinate which is generated based on the behavior for the resources of the system may be implemented such that four coordinate axes corresponding to behaviors related with the file, the process, the registry, and the network meet each other at a center point.

The behavior modeling unit may create a process model having a quadrangular shape in which the behavior analysis result for the resources of the system is represented on the four coordinate axes and points which are represented on the four coordinate axes serve as apexes.

The coordinate which is generated based on the behavior of the the resource of the system may be implemented such that four coordinate axes corresponding to single behaviors related with the file, the process, the registry, and the network and coordinate axes corresponding to a composite behavior related with at least two resources of the systems among the file, the process, the registry, and the network meet each other at the center point.

When a behavior related with at least two resources of the systems occurs by the process, the behavior modeling unit may define a position of a coordinate axis corresponding to the composite behavior on the coordinate which is generated based on the behavior of the resource of the system based on at least one of a ratio, a frequency, and a correlation of the behavior related with at least two resources.

When a behavior related with at least two resources of the systems occurs by the process, the behavior modeling unit may create a process model having a polygonal shape in which a behavior analysis result for the resources of the system is represented on a coordinate axis which is implemented on a coordinate generated based on the behavior for the resources of the system and the points which are represented on the coordinate axes serve as apexes.

The suspicious behavior determining unit may determine a suspicious behavior for the process based on the result of profiling the suspicious behavior for a malicious code.

The suspicious behavior determining unit may analyze a degree of risk of the behavior for the resources of the system which occurs in the process from the result of profiling the suspicious behavior of the malicious code to determine the suspicious behavior for the process.

The suspicious behavior determining unit may determine the suspicious behavior for the process based on the number and a distance of apexes of the process behavior model.

Another exemplary embodiment of the present invention provides an abnormal behavior detecting method, including: analyzing a behavior which occurs for resources of a system based on data collected from a process while the process is executed on the system; modeling a behavior analysis result for each resource of the system on a coordinate which is generated based on the behavior for the each resource of the system to create a process behavior model corresponding to the each resource of the system; determining a suspicious behavior of the process in accordance with the type of process behavior model which is implemented on the coordinate which is generated based on the behavior for the each resource of the system; and detecting a process in which the suspicious behavior occurs as an abnormal behavior process in accordance with the determining result of the suspicious behavior.

The present invention has advantages that by analyzing a behavior of data occurring during a process operation for the resources of the system and visualizing the behavior in a behavior area corresponding to the resource of the system, it is possible to figure out a ratio of a normal behavior and a suspicious behavior which are performed by the process in accordance with a behavior distribution pattern for the resources of the system and easily detect a process which performs the abnormal behavior in accordance with the ratio.

The present invention is advantageous in that a normal behavior, behaviors of a malicious code or suspicious behaviors for the resources of the system are modeled to detect a process which performs an abnormal behavior through a behavior model.

The present invention has an advantage that suspicious behaviors which occur during a prior preparation process of the malicious code for performing malicious behavior are detected to cope with the cyber target attack in advance.

### BRIEF DESCRIPTION OF THE DRAWINGS

FIG. 1 is a diagram illustrating a configuration of an abnormal behavior detecting apparatus according to an exemplary embodiment of the present invention.

FIG. 2 is an exemplary diagram which is referred to explain an operation of modeling a behavior for resources of a system which is applied to the abnormal behavior detecting apparatus according to an exemplary embodiment of the present invention.

FIGS. 3 to 6 are exemplary diagrams illustrating a behavior model for the resources of the system which is applied to the abnormal behavior detecting apparatus according to an exemplary embodiment of the present invention.

FIG. 7 illustrates a flowchart of an operation of an abnormal behavior detecting method according to an exemplary embodiment of the present invention.

### DETAILED DESCRIPTION OF THE EXEMPLARY EMBODIMENTS

Hereinafter, the present invention will be described in detail with reference to accompanying drawings. In this case, like components are denoted by like reference numerals in the drawings. Further, the detailed description of a function and/or a configuration which has been already known will be omitted. In the following description, parts which are required to understand an operation according to various exemplary embodiments will be mainly described and a description of components which may cloud a gist of the description will be omitted.

Some components of the drawings will be exaggerated, omitted, or schematically illustrated. However, a size of the component does not completely reflect an actual size and thus the description is not limited by a relative size or interval of the components illustrated in the drawings.

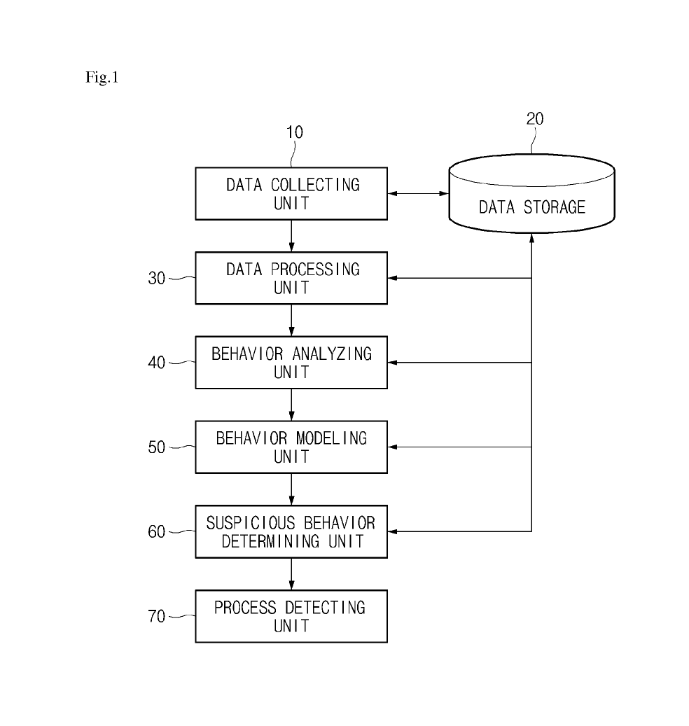

FIG. 1 is a diagram illustrating a configuration of an abnormal behavior detecting apparatus according to an exemplary embodiment of the present invention.

Referring to FIG. 1, an abnormal behavior detecting apparatus according to an exemplary embodiment of the present invention may include a data collecting unit 10, a data storage 20, a data processing unit 30, a behavior analyzing unit 40, a behavior modeling unit 50, a suspicious behavior determining unit 60, and a process detecting unit 70.

First, the data collecting unit 10 collects data related to a process from a plurality of systems. The data collecting unit 10 may collect data related to a process which is generated in the plurality of systems in real time and may collect the data in a predetermined time unit. In this case, the data which is collected by the data collecting unit 10 may vary depending on an operating system of the system. Here, the system may be a host and a server in which the process operates. The data collecting unit 10 provides the data collected from the plurality of systems to the data storage 20.

The data storage 20 is a big data platform based storage which stores and processes massive data and data which is collected from the plurality of systems by the data collecting unit 10 is stored therein. For example, as a big data platform which is applied to the data storage 20, a hadoop which is an open source type distributed system may be used. In this case, a hadoop distributed file system (HDFS) and a HDFS based distributed database (HBase) may be applied as the massive data storage 20 and an in-memory database (in-memory DB) based open source database management system which is MySQL cluster may be applied as a real-time data processing storage.

Information on a behavior area for resources of a system may be stored in the data storage 20 and a behavior of a resource of the system which occurs in a process in a normal state may be stored. Further, information on a suspicious behavior for the resources of the system of a process which is classified as a malicious code in advance may be stored in the data storage 20 and a profiling result for the suspicious behavior may be stored. Therefore, the behavior analyzing unit 40 may analyze the behavior of the process based on the information stored in the data storage 20 and the behavior modeling unit 50 may model a behavior analysis result of the process in accordance with the information of the behavior area for the resources of the system to visualize the result. Further, the suspicious behavior determining unit 60 may determine a suspicious behavior in the process based on the profiling result of the suspicious behavior.

Here, the behavior which is performed by the process in the operating system of the system is a behavior related with at least one resource of the system of a file, a registry, a process, and a network. Even though the process which includes the malicious code also may perform various exceptional behaviors by the malicious code, the process basically performs a function inherent to the process which is included in a category of above-described four behaviors.

Basically, the malicious code may perform a file creating step, a registry registering step, a process operating step, and a network activity step as a prior preparation process for performing a malicious behavior in the operating system of the system. Therefore, the abnormal behavior detecting apparatus may profile a suspicious behavior which may occur by the malicious code in the file creating step, the registry registering step, the process operating step, and the network activity step of the system and suspect a process which performs a behavior similar to the profiled behavior as an abnormal behavior process.

The following [Table 1] represents a suspicious behavior by the malicious code for every execution step in the system, a behavior category, and a used API.

TABLE 1

| | Behavior | Behavior | | | |
|---|---|---|---|---|---|
| | per stage | category | Suspicious behavior | Used API | Remark |
| (a) | File | File | Create file in system folder; | CreateFile | Copy its |
| | creating | | Change file name in system | ReadFile/WriteFile | own file |
| | step | | folder; | CopyFile | |
| | | | Create file in temporary | GetSystemDirectory | |
| | | | folder; and | GetWindowsDirectory | |
| | | | Create execution file in | | |
| | | | temporary folder. | | |
| | | Network | Access network | URLDownloadToFileA | Download |
| | | file | Create execution file | | file through |
| | | | | | network |
| | | File | Create file | FindResourceA | Drop |
| | | | | LoadResource | internal file |
| (b) | Registry | Registry | Register/delete registry | RegCreateKey | |
| | registering | | Register/delete service | RegOpenKeyExA | |
| | step | | Add autorun item | RegSetValueExA | |
| | | | Add BHO item | RegQueryValueEXA | |
| | | | | CreateServiceA | |
| | | | | OpenServiceA | |
| | | | | StartServiceA | |
| (c) | Process | Process | Create other process | CreateProcess | |
| | operating | | Terminate other process | FindProcess | |
| | step | | Search specific process | TerminateProcess | |
| | | | Create thread | CreateThread | |
| | | | Inject into DLL type code | CreateRemoteThread | |
| | | | process | WriteProcessMemory | |
| | | | | ShellExecute | |
| (d) | Network | Network | Port open/binding | WSAStartup | |
| | activity | | Connect network | WSASend | |
| | step | | Transmit data | Socket/send/recv | |
| | | | | Listen/accept | |
| | | | | Gethostbyname | |
| | | | | InternetGetConnectedState | |

(a) of [Table 1] represents suspicious behaviors which are performed by the malicious code in the file creating step of the system.

The malicious code may copy a malicious code file in a system folder or a temporary folder in order to hide a file which is a substantial malicious code. In this case, the malicious code may perform a behavior which creates a malicious code file in the system folder or changes a file name of the system folder and creates a file or an execution file in the temporary folder. In this case, an API which is used by the malicious code may be Createfile, ReadFile/WriteFile, CopyFile, GetSystemDirectory, and GetWindowsDirectory.

The malicious code may perform a behavior which accesses the network to download another malicious code from the outside or takes out a file corresponding to another malicious code included in the process to drop the file. In this case, the API which is used by the malicious code may be URLDownloadToFileA, FindResourceA, and LoadResource.

As described above, the behavior which is performed by the malicious code in the file creating step illustrated in (a) may be included in a behavior area of the file and a network.

In the meantime, (b) of [Table 1] represents suspicious behaviors which are performed by the malicious code in the registry registering step of the system.

The malicious code may perform a behavior which registers a path of the malicious code file in the registry and a service to be executed at the time of booting the system in order to remain in the system as long as possible or deletes some file paths and registers a path of the malicious code file in an autorun item or a browser helper object (BHO) item. In this case, the API which is used by the malicious code may be RegCreateKey, RegOpenKeyExA, RegSetValueExA, RegQueryValueEXA, CreateServiceA, OpenServiceA, and StartServiceA.

As described above, the behavior which is performed by the malicious code in the registry registering step illustrated in (b) may be included in a behavior area of the registry.

In the meantime, (c) of [Table 1] represents suspicious behaviors which are performed by the malicious code in the process operating step of the system.

The malicious code may mainly operate in the form of an independent process on the system or be injected in other normal process to operate in a thread state. During this process, the malicious code may perform a behavior which creates or ends another process, searches a specific process or creates the thread. Further, the malicious code may perform a behavior which injects a DLL type code in the process. In this case, the API which is used by the malicious code may be CreateProcess, FindProcess, TerminateProcess, CreateThread, CreateRemoteThread, WriteProcessMemory, and ShellExecute.

As described above, the behavior which is performed by the malicious code in the process operating step illustrated in (c) may be included in a behavior area of the process.

In the meantime, (d) of [Table 1] represents suspicious behaviors which are performed by the malicious code in the network activity step of the system.

The malicious code may perform a network activity for leakage of information of the system, reception of a command of an attacker or another malicious code, and propagation of the malicious code. In this case, the malicious code may perform a behavior which opens and binds a communication port, connects the network, and transmits data. In this case, the API which is used by the malicious code may be WSAStartup, WSASend, Socket/send/recvlisten/accept, gethostbyname, and InternetGetConnectedState.

As described above, the behavior which is performed by the malicious code in the network activity step illustrated in (d) may be included in a behavior area of the network.

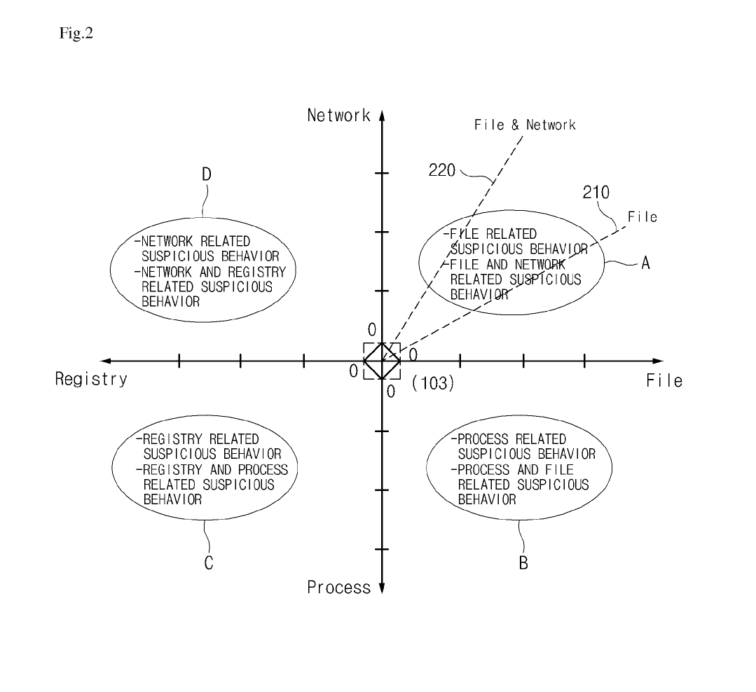

The abnormal behavior detecting apparatus according to the exemplary embodiment of the present invention may create a behavior model corresponding to the process in accordance with a rate and a frequency of the behavior with respect to each resource of the system when the process operates in a normal state. In this case, the behavior model of each process may be visualized as a quadrangular shape which connects four behavior characteristics based on characteristics of the behaviors related with the file, the registry, the process, and the network and detect the abnormal behavior process based on the shape of the behavior model of the process. A specific operation thereof will be described with reference to the exemplary embodiment of FIGS. 2 to 6.

In this case, the abnormal behavior detecting apparatus analyzes behaviors which are basically performed by the process which includes the malicious code to profile the behaviors and determine the profiled behavior as a suspicious behavior in order to increase the accuracy of detecting the abnormal behavior.

Here, [Table 2] represents a result of profiling the suspicious behaviors of the malicious code represented in [Table 1].

TABLE 2

| | | Code of | |
|---|---|---|---|
| | | suspicious | Degree |
| | Suspicious behavior | behavior | of risk |
| (a) | Create file | F1 | M |
| | Create execute file | F2 | H |
| | Create file in system folder | F3 | H |
| | Change file name in system folder | F4 | H |
| | Delete file in system folder | F5 | H |
| | Create file in temporary folder | F6 | L |
| | Create execute file in temporary folder | F7 | H |
| (b) | Register registry | R1 | M |
| | Delete registry | R2 | H |
| | Register service | R3 | M |
| | Delete service | R4 | H |
| | Add autorun item | R5 | H |
| | Add BHO item | R6 | M |
| (c) | Create process | P1 | H |
| | Terminate process | P2 | H |
| | Search specific process | P3 | H |
| | Create thread | P4 | M |
| | Inject DLL type code | P5 | H |
| (d) | Open port | N1 | M |
| | Bind port | N2 | M |
| | Connect network | N3 | M |
| | Disconnect network | N4 | L |
| | Transmit data | N5 | M |
| | Receive data | N6 | M |

(a) of [Table 2] represents a profiling result of suspicious behaviors which may occur during the file creating step, for example, behaviors which create a file, create an execute file, create a file in a system folder, change a file name in the system folder, delete a file of the system folder, create a file in a temporary folder, and create an execute file in the temporary folder and the abnormal behavior detecting apparatus assigns suspicious behavior codes F1 to F7 to the suspicious behaviors related with the file as the profiling result and assigns a degree of risk in accordance with each suspicious behavior.

(b) of [Table 2] represents a profiling result of suspicious behaviors which may occur during the registry registering step, for example, behavior which register a registry, delete the registry, register a service, delete the service, add an autorun item, and add a BHO item and the abnormal behavior detecting apparatus assigns suspicious behavior codes R1 to R6 to the suspicious behaviors related with the registry as the profiling result and assigns a degree of risk in accordance with each suspicious behavior.

(c) of [Table 2] represents a profiling result of suspicious behaviors which may occur during the process operating step, for example, behaviors which create a process, end the process, search a specific process, create a thread, and inject a DLL type code and the abnormal behavior detecting apparatus assigns suspicious behavior codes P1 to P5 to the suspicious behaviors related with the process as the profiling result and assigns a degree of risk in accordance with each suspicious behavior.

(d) of [Table 2] represents a profiling result of suspicious behaviors which may occur during the network activity step, for example, behaviors which open a port, bind the port, connect the network, disconnect the network, transmit data, and receive data and the abnormal behavior detecting apparatus assigns suspicious behavior codes N1 to N6 to the suspicious behaviors related with the network as the profiling result and assigns a degree of risk in accordance with each suspicious behavior.

Here, among the degrees of risk represented in [Table 2], H indicates a high risk group, M indicates an intermediate risk group, and L indicates a low risk group and different degrees of risk may be assigned in accordance with the characteristic of each suspicious behavior.

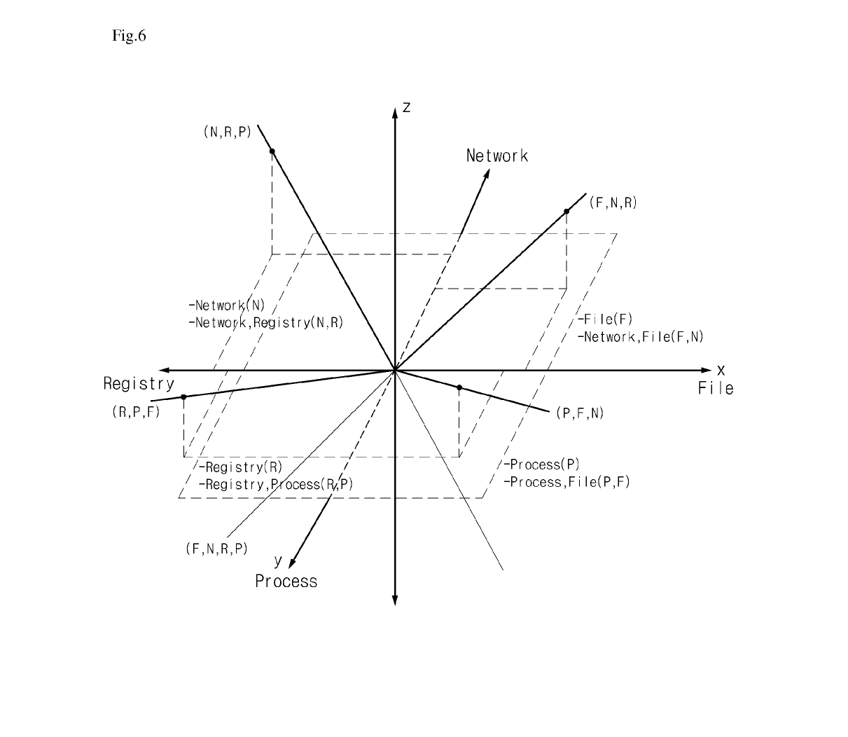

In the meantime, [Table 2] represents a part of single suspicious behavior profiling per behavior category of the process but the degree of risk may be subdivided according to an exemplary embodiment. Further, even though not represented in FIG. 2, a composite suspicious behavior in which suspicious behaviors are combined may be profiled as illustrated in FIG. 6.

As described above, the result of profiling the suspicious behavior of the malicious code is stored in the data storage 20 to be used to analyze the behavior of the process in the behavior analyzing unit 40.

In the meantime, the data processing unit 30 manages data stored in the data storage 20 and when the data collected from the process is stored in the data storage 20, the data processing unit 30 provides the stored data to the behavior analyzing unit 40 using batch and/or real-time data processing technology.

The behavior analyzing unit 40 analyzes the behavior of the process based on the data provided from the data processing unit 30. In this case, the behavior analyzing unit 40 analyzes the behavior of the process based on the profile of the suspicious behavior of the malicious code which is defined by a ratio, a frequency, and a correlation of the behavior which occurs for every behavior area of the resource of the system which occurs in the process.

The process behavior analysis result from the behavior analyzing unit 40 may be stored in a relational data base management system (RDBMS) or an HBase of the data storage 20 and also provided to the behavior modeling unit 50. The behavior modeling unit 50 models the process behavior analyzing result of the behavior analyzing unit 40 in a behavior area for the resources of the system to visualize the result so as to be recognized by a user. For example, the process behavior area is illustrated in FIG. 2. In this case, the behavior modeling unit 50 analyzes the ratio and the frequency of the behavior for the resources of the system and the correlation of the behaviors in accordance with the operation of the process and models the result in the behavior area as illustrated in FIG. 2. Therefore, the operation of modeling the behavior for the resources of the system of the process will be described with reference to FIGS. 2 to 6.

The suspicious behavior determining unit 60 determines a degree of risk of a behavior model of the process which is currently performed based on the profile of the behavior of the malicious code represented in [Table 2]. In this case, when a behavior which is suspected as a malicious code occurs from one area among the behavior areas corresponding to the file, the registry, the process, and the network, the suspicious behavior determining unit 60 may determine that the degree of risk is low.

In the meantime, the suspicious behavior determining unit 60 assigns a weight for the degree of risk in accordance with the number of behavior areas in which the suspicious behavior occurs to determine the degree of risk. For example, when a behavior which is suspected as a malicious code occurs from at least two areas among the behavior areas corresponding to the file, the registry, the process, and the network, the suspicious behavior determining unit 60 assigns the weight to the degree of risk for the behavior areas to determine that the degree of risk is higher than that when the suspicious behavior occurs in one behavior area.

The suspicious behavior determining unit 60 may determine whether the process performs a normal behavior or a suspicious behavior based on the type of the behavior model of the process which is modeled by the behavior modeling unit 50 and the degree of risk from the profile of the suspicious behavior of the malicious code. If it is determined that the process performs the normal behavior, the suspicious behavior determining unit 60 reflects the state of the process to the normal behavior process model.

In contrast, if it is determined that the process performs the suspicious behavior, the suspicious behavior determining unit 60 provides the determining result of the suspicious behavior to the process detecting unit 70. Therefore, the process detecting unit 70 detects the process as the abnormal behavior process and processes the process in accordance with the cyber attack detection and reaction policy of the system.

FIG. 2 is an exemplary diagram which is referred to explain an operation of modeling a behavior for the resources of the system which is applied to the abnormal behavior detecting apparatus according to an exemplary embodiment of the present invention.

FIG. 2 illustrates an initial model for modeling the behavior of the process which consists of coordinate axes and reference points corresponding to the resources of the systems and is divided into behavior areas for the resources of the system with respect to the axes. Here, the behavior of each resource of the system which is performed by all the processes is zero at the initial stage and the behavior models of the resources of the systems have a rhombus shape with the reference points corresponding to zero as apexes.

First, a horizontal axis at the right of a center point is a coordinate axis for a file behavior and a horizontal axis at the left of the center point is a coordinate axis for a registry behavior. Further, a vertical axis above the center point is a coordinate axis for a network behavior and a vertical axis below the center point is a coordinate axis for a process behavior. Here, the positions of the coordinate axes may be defined by the behaviors having correlation for the resources of the system.

In this case, an “A” area of FIG. 2 models a behavior related with the file and a behavior related with the file and the network. Further a “B” area models a process related suspicious behavior and a behavior related with the process and the file. Further, a “C” area models a behavior related with the registry and a behavior related with the registry and the process. Furthermore, a “D” area models a behavior related with the network and a behavior related with the network and the registry.

For example, in a graph 210 which is close to the coordinate axis for the file behavior in the “A” area, a coordinate axis for modeling the suspicious behavior related with the file is additionally formed. In the meantime, for the behavior related with the file and the network, a coordinate axis 220 may be added so as to be closer to the coordinate axis for the network behavior in 210.

In other words, in the “A”, “B”, “C”, and “D” areas, correlations of the behaviors which are included in the behavior category of the two coordinate axes which form the areas are analyzed to create a new coordinate axis in which two behaviors are combined and the process behavior model may be represented based on the new coordinate axis. In this case, a coordinate axis is additionally formed in the “A”, “B”, “C”, and “D” areas so that when the process behavior is modeled based on the coordinate axis, it may be considered as a suspicious behavior. In this case, as the suspicious behaviors which are performed in the process are increased, the number of coordinate axes formed in the “A”, “B”, “C”, and “D” areas is increased.

Therefore, the user may easily figure out which behavior is performed by the process based on the coordinate axes and the process behavior modeled in the four behavior areas.

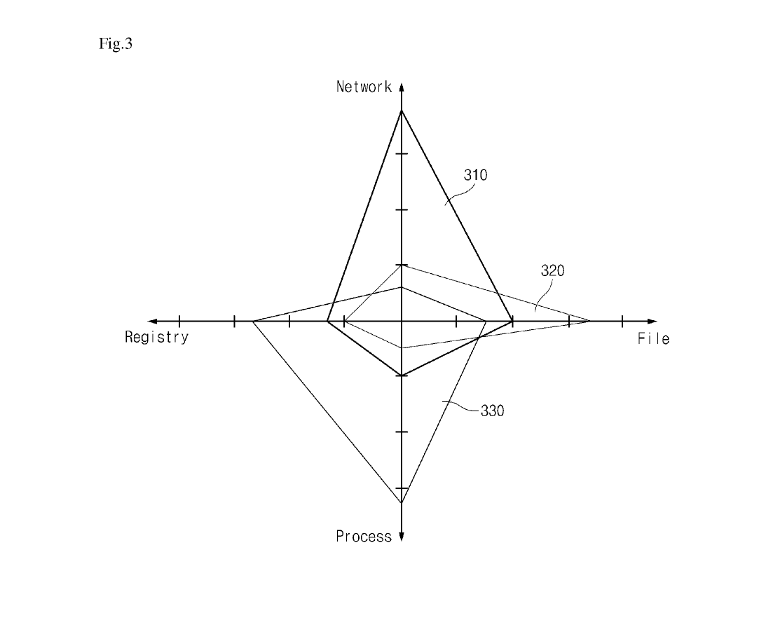

FIGS. 3 to 6 are exemplary diagrams illustrating a behavior model for the resources of the system which is applied to the abnormal behavior detecting apparatus according to an exemplary embodiment of the present invention.

First, FIG. 3 illustrates a behavior model of each process and illustrates a process behavior in a normal state.

A process of the behavior model corresponding to 310 in FIG. 3 mainly performs behaviors related with the network and the file rather than the behaviors related with the registry or the process. In contrast, a process of the behavior model corresponding to 320 performs a file related behavior much more than the behaviors related with the network, the registry, and the process. Contrary to the process corresponding to 310, a process of the behavior model corresponding to 330 mainly performs a behavior related with the registry or the process rather than the behavior related with the network or the file.

As described above, the behavior model may be modeled so as to have various types depending on which operation is performed by the process. In the case of three behavior models illustrated in FIG. 3, all apexes are disposed on the coordinate axes for the file, network, registry, and process behavior so that the abnormal behavior detecting apparatus determines that the processes perform the behaviors which operate in a normal range.

When the process which usually performs the behavior as illustrated in FIG. 3 has a difference in the behavior ratio or performs a new behavior, the abnormal behavior detecting apparatus may primarily suspect the behavior of the process.

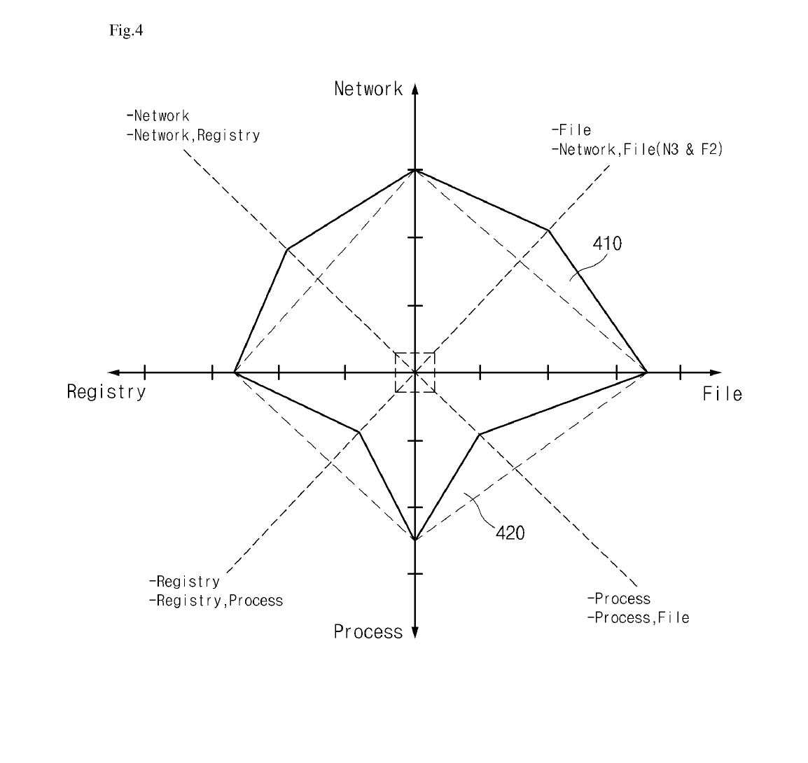

FIG. 4 illustrates a process behavior model for suspicious behaviors which are considered as malicious behaviors.

Referring to FIG. 4, a process behavior model corresponding to 420 relates to a process which evenly performs the file, network, registry, and process behaviors and all apexes are disposed on the coordinate axes for the file, network, registry, and process behaviors in this case so that the abnormal behavior detecting apparatus determines that the processes perform the behaviors which operate in a normal range.

In the meantime, the process behavior model corresponding to 410 has a polygonal shape in which new coordinate axes are formed in the “A”, “B”, “C”, and “D” areas illustrated in FIG. 2 and the existing coordinate axes and the new coordinate axes formed in the “A”, “B”, “C”, and “D” areas become apexes. Therefore, the process performs a behavior in which two behaviors of the file, network, registry, and process behaviors are combined so that the behavior may be determined as a suspicious behavior.

For example, a coordinate axis formed between the coordinate axis for the file behavior and the coordinate axis for the network behavior in the process behavior model 410 indicates that the network related behavior, that is, a behavior N3 of accessing a network, and the file related behavior, that is a behavior F2 of creating an execute file occur together among the profiles represented in [Table 2] so that the degree of risk is increased as compared with the single suspicious behavior. Therefore, it may be determined that the suspicious behavior occurs.

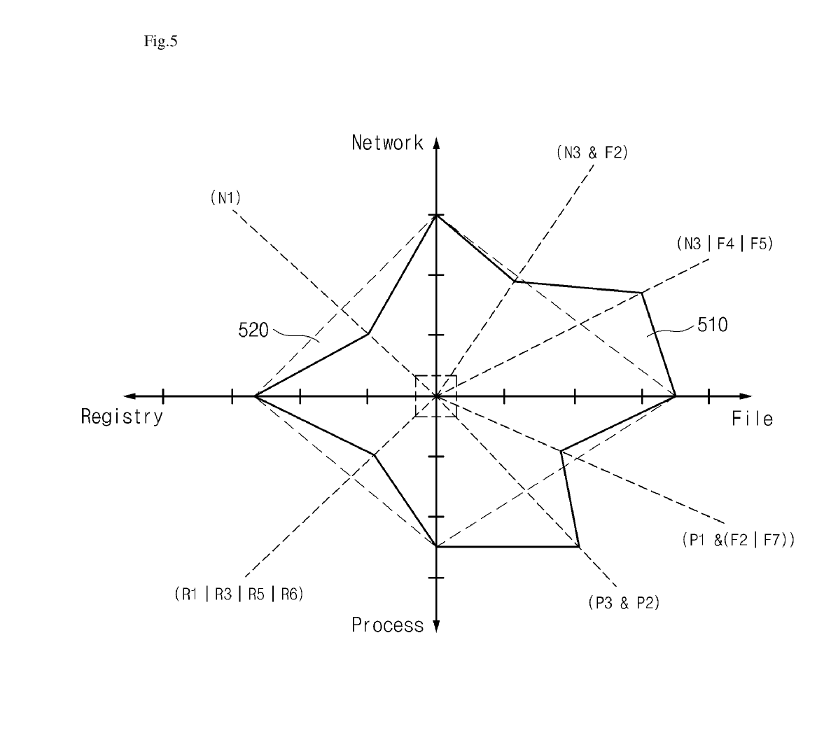

FIG. 5 illustrates a process behavior model for suspicious behaviors which are different from those of FIG. 4.

Referring to FIG. 5, similarly to the process behavior model corresponding to 420 of FIG. 4, a process behavior model corresponding to 520 represents a process which evenly performs the file, network, registry, and process behaviors and all apexes are disposed on the coordinate axes for the file, network, registry, and process behaviors in this case so that the abnormal behavior detecting apparatus determines that the processes perform the behaviors which operate in a normal range.

In the meantime, the process behavior model corresponding to 510 has a polygonal shape in which new coordinate axes are formed in the “A”, “B”, “C”, and “D” areas illustrated in FIG. 2 and the existing coordinate axes and the new coordinate axes formed in the “A”, “B”, “C”, and “D” areas become apexes. Therefore, the process performs a behavior in which two behaviors of the file, network, registry, and process behaviors are combined so that the behavior may be determined as a suspicious behavior. However, if in the process behavior model corresponding to 410, one coordinate axis is newly formed in each of the “A”, “B”, “C”, and “D” areas, in the process behavior model corresponding to 510, two coordinate axes are newly formed in each of the “A” and “B” areas and one coordinate axis is newly formed in each of the “C” and “D” areas.

In this case, the process behavior model corresponding to 510 has more apexes than the process behavior model corresponding to 410 of FIG. 4 so that the degree of risk may be increased more. Therefore, the abnormal behavior detecting apparatus may determine that a suspicious behavior occurs in the process.

As described above, as the number of apexes of the process behavior model is increased so as to have an uneven shape, a distance between the center point and the apex is increased so that the abnormal behavior detecting apparatus determines that the degree of risk of the process is higher as the process behavior model has a wider area. Further, when the shapes of the process behavior models are simple, even if the models have the same shape, the abnormal behavior detecting apparatus determines that the degree of risk is lower as the process behavior model has a smaller area. Therefore, the user may intuitively figure out the type of process behavior model at a glance so that the user may easily figure out whether the process is a suspicious behavior process.

In the meantime, FIG. 6 illustrates a process behavior model in which at least three behaviors of resources of the systems are combined.

The process behavior model illustrated in FIG. 6 is formed by combining at least three behaviors so that nine categories of behavior models as represented in [Table 3] below may be implemented in the form of a three dimensional coordinate (x, y, z).

TABLE 3

| | X | Y | Z | Composite | |
|---|---|---|---|---|---|
| No. | axis | axis | axis | behavior | Type |
| 1 | (+) | (−) | | (F), (F, N) | (F & . . . F), (F & N), |
| | | | | | (N & F), (F&F&N&F), . . . |
| 2 | (−) | (−) | | (N), (N, R) | (N & . . . N), (N & R), |
| | | | | | (R & N), . . . |
| 3 | (−) | (+) | | (R), (R, P) | (R & . . . R), (R & P), |
| | | | | | (P & R), . . . |
| 4 | (+) | (+) | | (P), (P, F) | (P & . . . P), (P & F), |
| | | | | | (F & P), . . . |
| 5 | (+) | (−) | (+) | (F, N, R) | (F & R), (F & N & R), |
| | | | | | (N & F & R), . . . |
| 6 | (−) | (−) | (+) | (N, R, P) | (N & P), (N & R & P), |
| | | | | | (R & N & P), . . . |
| 7 | (−) | (+) | (+) | (R, P, F) | (R & F), (R & P & F), |
| | | | | | (P & R & F), . . . |
| 8 | (+) | (+) | (+) | (P, F, N) | (P & N), (P & F & N), |
| | | | | | (F & P & N), . . . |
| 9 | | | (−) | (F, N, R, P) | |

In other words, if it is assumed that the file behavior is denoted by F, the network behavior is denoted by N, the registry behavior is denoted by R, and the process behavior is denoted by P as the composite behavior, the process behavior may be implemented as nine composite behavior categories such as (F) and/or (F, N), (N) and/or (N, R), (R) and/or (R, P), (P) and/or (P, F), (F, N, R), (N, R, P), (R, P, F), (P, F, N) and (F, N, R, P).

Here, the process behavior model which may be visualized in the composite behavior area of FIG. 6 may be modeled as various types in accordance with the combination of the behaviors, For example, (F, N) may be implemented as various types formed of {F, N} such as (F & N), (N & F), (F & N & F & F & N) and (F, N, R) may be implemented as a composite behavior model having all combinations which are formed of {F, N, R} except for (F & N), (N & F), (R & F) which are defined in another model.

In this case, like (F, N, R, P), the composite behavior in which all the file, the network, the registry, and the process are combined may be implemented using an area in which a z axis is negative.

However, the process behavior area illustrated in FIG. 6 describes an exemplary embodiment so that the area may be implemented as more various types in accordance with the combination.

An operation flow of the abnormal behavior detecting apparatus according to the exemplary embodiment of the present invention configured as described above will be described below in detail.

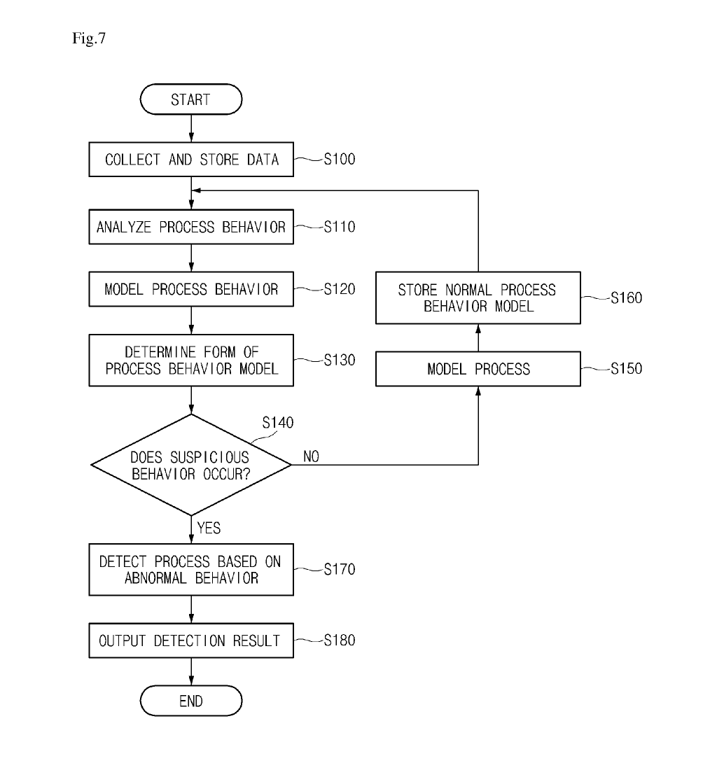

FIG. 7 illustrates a flowchart of an operation of an abnormal behavior detecting method according to an exemplary embodiment of the present invention. As illustrated in FIG. 7, the abnormal behavior detecting apparatus collects data from a plurality of processes to store the data in a massive data storage in step S100 and analyzes the behavior of the process based on the data which is stored in the data storage during step S100, in step S110.

In step S110, the abnormal behavior detecting apparatus may analyze a ratio, a frequency, and a correlation of behaviors related with the resources of the systems, for example, the file, the registry, the network, and the process based on a result of profiling the suspicious behavior for the malicious code in advance.

Next, the abnormal behavior detecting apparatus models the behavior of the process in the behavior area of the resource of the system in step S120 based on the behavior analysis result of step S110 and determines a type and a degree of risk of the process behavior model which is created in step S120, in step S130 to determine whether the process is a suspicious behavior process in step S140. An operation of determining the suspicious behavior process in step S140 may be specifically described with reference to the exemplary embodiment of FIGS. 2 to 6.

If it is confirmed that the process is a normal behavior process in step S140, the abnormal behavior detecting apparatus models a normal behavior of the process in step S150 to store the normal behavior process model in step S160 to be used as a normal behavior process determining reference later.

In the meantime, if it is confirmed that the process is a suspicious behavior process in step S140, the abnormal behavior is detected based on the suspicious behavior of the process in step S170 and a result of detecting the abnormal behavior is output in step S180. In this case, the abnormal behavior detecting apparatus processes the detected abnormal behavior process in accordance with the cyber attack detection and reaction policy of the system.

When the various exemplary embodiments described above are executed by one or more computers or processors, the present invention may be implemented as a code which is readable by a processor in a process readable recording medium. The process readable recording medium includes all types of recording devices in which data readable by a processor is stored. Examples of the process readable recording medium include a ROM, a RAM, a CD-ROM, a magnetic tape, a floppy disk, and an optical data storing device and also include a medium which is implemented as a carrier wave such as the transmission through the Internet. Further, the process readable recording medium is distributed in computer systems connected through a network and the processor readable code is stored therein and executed in a distributed manner.

The specified matters such as specific elements and the limited exemplary embodiments and drawings in the present invention have been disclosed for broader understanding of the present invention, but the present invention is not limited to the exemplary embodiments, and various modifications, additions and substitutions are possible by those skilled in the art without departing from an essential characteristic of the present invention. Therefore, the spirit of the present invention is defined by the appended claims rather than by the above-described exemplary embodiments, and all changes and modifications that fall within metes and bounds of the claims, or equivalents of such metes and bounds are therefore intended to be embraced by the range of the spirit of the present invention.

What is claimed is:

1. An abnormal behavior detecting apparatus, comprising:
a behavior analyzing unit which analyzes a behavior which occurs for resources of a system based on data collected from a process while the process is executed on the system;
a behavior modeling unit which models a behavior analysis result for each resource of the system on a coordinate which is generated based on the behavior for the each resource of the system to create a process behavior model corresponding to the each resource of the system;
a suspicious behavior determining unit which determines a suspicious behavior of the process in accordance with the type of process behavior model which is implemented on the coordinate which is generated based on the behavior for the each resource of the system; and
a process detecting unit which detects a process in which the suspicious behavior occurs as an abnormal behavior process in accordance with the determining result of the suspicious behavior determining unit.

2. The apparatus of claim 1, wherein the behavior analyzing unit analyzes at least one of a ratio, a frequency, and a correlation of the behavior which occurs for the resources of the system.

3. The apparatus of claim 1, wherein the resource of the system includes a file, a process, a registry, and a network.

4. The apparatus of claim 3, wherein the coordinate which is generated based on the behavior for the resources of the system is implemented such that four coordinate axes corresponding to behaviors related with the file, the process, the registry, and the network meet each other at a central point.

5. The apparatus of claim 4, wherein the behavior modeling unit creates a process model having a quadrangular shape in which the behavior analysis result for the resources of the system is represented on the four coordinate axes and points which are represented on the four coordinate axes serve as apexes.

6. The apparatus of claim 3, wherein the coordinate which is generated based on the behavior of the resource of the system is implemented such that four coordinate axes corresponding to single behaviors related with the file, the process, the registry, and the network and coordinate axes corresponding to a composite behavior related with at least two resources of the systems among the file, the process, the registry, and the network meet each other at the central point.

7. The apparatus of claim 6, wherein when a behavior related with at least two resources of the systems occurs by the process, the behavior modeling unit defines a position of a coordinate axis corresponding to the composite behavior on the coordinate which is generated based on the behavior of the resource of the system based on at least one of a ratio, a frequency, and a correlation of the behavior related with at least two resources.

8. The apparatus of claim 6, wherein when a behavior related with at least two resources of the systems occurs by the process, the behavior modeling unit creates a process model having a polygonal shape in which a behavior analysis result for the resources of the system is represented on a coordinate axis which is implemented on a coordinate generated based on the behavior for the resources of the system and the points which are represented on the coordinate axes serve as apexes.

9. The apparatus of claim 1, wherein the suspicious behavior determining unit determines a suspicious behavior for the process based on the result of profiling the suspicious behavior for a malicious code.

10. The apparatus of claim 9, wherein the suspicious behavior determining unit analyzes a degree of risk of the behavior for the resources of the system which occurs in the process from the result of profiling the suspicious behavior of the malicious code to determine the suspicious behavior for the process.

11. The apparatus of claim 1, wherein the suspicious behavior determining unit determines the suspicious behavior for the process based on the number and a distance of apexes of the process behavior model.

12. An abnormal behavior detecting method, comprising:
analyzing a behavior which occurs for resources of a system based on data collected from a process while the process is executed on the system;
modeling a behavior analysis result for each resource of the system on a coordinate which is generated based on the behavior for the each resource of the system to create a process behavior model corresponding to the each resource of the system;
determining a suspicious behavior of the process in accordance with the type of process behavior model which is implemented on the coordinate which is generated based on the behavior for the each resource of the system; and
detecting a process in which the suspicious behavior occurs as an abnormal behavior process in accordance with the determining result of the suspicious behavior.

13. The method of claim 12, wherein the analyzing of a behavior includes analyzing at least one of a ratio, a frequency, and a correlation of the behavior which occurs for the resources of the system.

14. The method of claim 12, wherein the creating of a behavior model includes:
representing the behavior analysis result for the resources of the system on a coordinate where four coordinate axes corresponding to behaviors related with a file, a process, a registry, and a network meet each other at a center point, and
creating a process model having a quadrangular shape with points which are represented on the four coordinate axes as apexes.

15. The method of claim 12, wherein the creating of a behavior model includes:
representing a behavior analysis result for the resources of the system on a coordinate where four coordinate axes corresponding to behaviors related with a file, a process, a registry, and a network and coordinate axes corresponding to a behavior related with at least two resources of the systems among the file, the process, the registry, and the network meet each other at the center point; and
creating a process model having a polygonal shape with points which are represented on each of the coordinate axes implemented on the coordinate as apexes.

16. The method of claim 15, wherein when a behavior related with at least two resources of the systems occurs by the process, the creating of a behavior modeling includes defining a position of a coordinate axis related with at least two resources of the systems on the coordinate based on at least one of a ratio, a frequency, and a correlation of the behavior related with at least two resources.

17. The method of claim 12, wherein the determining of a suspicious behavior includes analyzing a degree of risk of the behavior for the resources of the system which occurs in the process from the result of profiling the suspicious behavior of the malicious code to determine the suspicious behavior for the process.

18. The method of claim 12, wherein the determining of a suspicious behavior includes determining the suspicious behavior for the process based on the number and a distance of apexes of the process behavior model which is implemented on the coordinate created based on the behavior of the resource of the system.
